(19) United States
(12) Patent Application Publication
(10) Pub. No.: US 2008/0147651 A1
(43) Pub. Date: Jun. 19, 2008

(54) Pre-Entry Text Enhancement For Text Environments

(75) Inventors: Kulvir S. Bhogal, Fort Worth, TX (US); Gregory J. Boss, American Fork, UT (US); Alexandre Polozoff, Bloomington, IL (US); Timothy M. Waters, Hiram, GA (US)

Correspondence Address: CAHN & SAMUELS, LLP, 1100 17th STREET, NW, SUITE 401, WASHINGTON, DC, 20036, US

(73) Assignee: INTERNATIONAL BUSINESS MACHINES CORPORATION, Armonk, NY (US)

(21) Appl. No.: 11/610,559

(22) Filed: Dec. 14, 2006

(51) Int. Cl. G06F 17/00

(52) U.S. Cl. 707/6

(57) ABSTRACT

A method for providing text in text environments includes capturing text entered by a user of a text environment; matching the entered text to text in a database; creating an entry in the database when no match occurs; counting the number of times the text is used; and displaying at least one of the most highly-counted texts as at least one text activation mechanism to facilitate text entry and avoid retyping of the text. A system includes an agent comprising a controller and an interface module. The controller captures text and increments a counter for text that has been previously entered in a text environment, and the interface module comprises at least one text activation mechanism.

### I. FIELD OF THE INVENTION

The present invention relates to systems and methods for providing text to the user of a text environment, such as instant messaging, text messaging, text editing, or word processing applications.

### II. BACKGROUND OF THE INVENTION

There are a variety of applications that allow for text entry by a user. The most common text entry environments include word processors, e-mail clients, instant messaging applications, and simple text editors that involve the entry of text using keyboards or keyboard-like interface devices. Often, separate text entries contain the same data. This information has to be typed into a messaging or e-mail application several times during an editing or messaging session.

To assist with text entry, various clipboard applications allow for the reuse of text for an application. These clipboard programs contain functions that allow multiple clips to be stored and maintained. For example, a clipboard application may store a full clipboard history in a file, thus keeping a record of each piece of text that has been copied. The clips can be recalled by starting the application, searching for the clip, and then retrieving the clip using a mouse or a complex key sequence to recall the clip. These clipboard applications have no intelligence, but simply add text that is copied and pasted into a clipboard queue.

Additionally, keyboard sequencing applications exist that remember the keys that were typed and can recreate those sequences. Some applications have an autocompletion function that autoprompts and autocompletes words and/or phrases based upon the text entered. For example, As-U-Type provides automatic text replacement to correct common typing errors or misspelled words within a word processing or text editing program. Still other programs, for example the Windows® macro utility called AIM Keys, have text shortcuts and/or key shortcuts. When an assigned text shortcut or acronym is typed, the shortcut or acronym is expanded to other text (usually much longer text). A key shortcut works the same way as the text shortcut, but is a combination of keys. For example, the key shortcut Alt+Ctrl+t may be associated with the text “Thank you for your prompt answer.” When the Alt+Ctrl+t key combination is pressed, the text “Thank you for your prompt answer” is inserted.

### III. SUMMARY OF THE INVENTION

In an aspect of the invention, a method is provided for providing text in text environments. Text entered by a user is stored in a database. The entered text is matched to text in the database, or an entry is created in the database if no match occurs. The number of times the text is used is counted. The most highly-counted texts are displayed as at least one text activation mechanism to facilitate text entry and avoid retyping the text.

In another aspect of the invention, the entered text may be linked to at least one recipient. The number of times the entered text is sent to the at least one recipient is counted.

In another aspect of the invention, a system is provided for providing text in text environments. The system includes an agent comprising a controller and an interface module. The controller captures text and increments a counter for text that has been previously entered in a text environment. The interface module comprises at least one text activation mechanism to facilitate text entry and avoid retyping of the text.

In another aspect of the invention, a computer program product is provided comprising a computer useable medium having a computer readable program. When executed on a computer, the computer readable program causes the computer to store text entered by a user in a database for a text environment; match the entered text to text in the database; create an entry in the database when no match occurs; count the number of times the text is used; and display at least one of the most highly-counted texts as a text activation mechanism to facilitate text entry and avoid retyping the text.

### IV. BRIEF DESCRIPTION OF THE DRAWINGS

FIG. 1 is a flow diagram of an embodiment of the invention showing a method of populating a database.

FIG. 2 is a flow diagram of an embodiment of the invention showing a method of populating a database based upon a predetermined percentage match.

FIG. 3 is a flow diagram of an embodiment of the invention showing a method of using equivalency to track uses of text and/or recipients.

FIG. 4 is a flow diagram of an embodiment of the invention showing a method of using punctuation marks to parse entered text.

FIG. 5 illustrates a method for providing text to the user of a text environment.

FIG. 6 is a block diagram showing an illustrative system according to an embodiment of the invention.

FIG. 7 is a block diagram showing an illustrative agent according to an embodiment of the invention.

FIG. 8 illustrates an interface module of an instant messaging application according to an embodiment of the invention.

### V. DETAILED DESCRIPTION OF THE DRAWINGS

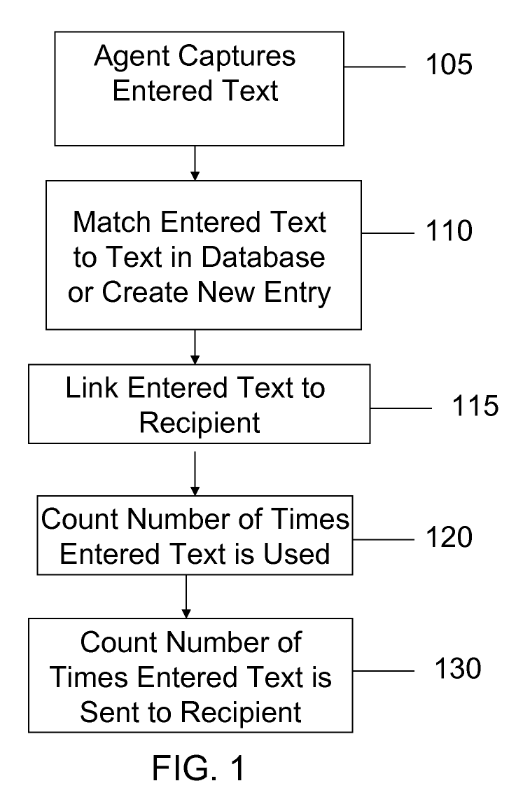

FIGS. 1-8 illustrate different exemplary systems and methods for tracking entry of text into a text environment. The text environment may include, but is not limited to, an e-mail application, a messaging application (e.g., instant messaging, cellular telephone text messaging or PDA text messaging), a word processing application, or any kind of text editor. Entered text may be tracked by an agent working with a database depending on the number of times the text is used. The database stores the text, and an incremental counter tracks usage of the text. The text that is most repeated is provided by the agent to the user as a text selection. Thus, the user avoids having to retype or reenter the text. In an embodiment, the number of available text selections and the basis of their availability may be user-defineable. In embodiments, the text may be parsed as one or more words, phrases, clauses, sentences, or abbreviations.

FIG. 1 illustrates an exemplary method for populating a database. As text is entered into a text environment, an application or agent captures the text, 105. The agent matches the entered text to text in the database or creates a new entry in the database when no match occurs, 110. In embodiments, the source of the text in the database may include previously-entered text by the user and new entries created as a result of unmatched text. However, text in the database may also include common expressions, text added or imported from other text environments or documents, or text entered by other users. In an embodiment where there is an identifiable recipient of the entered text, the agent may link the entered text to the recipient, 115. When there are multiple participants in an application (for example, an instant message chat session), the agent may link each participant, other than the user or sender, as a recipient of the text. Each time the entered text is matched to text in the database, the agent increments a counter record in the database for the repeated text, thereby counting the number of times the text has been used, 120. Each time the entered text is matched to text sent to at least one specific recipient, the agent may also increment a counter record for the at least one recipient, thereby counting the number of times the text is sent to the at least one recipient, 130. In at least one embodiment (e.g., for a messaging and/or e-mail text environment), a sender field may track text entered by users or senders and link the text to the user or sender. The counts for the sender and for the recipient may be kept as one count for a particular piece of captured text. Each counter record may be reset at any time by the user or at a predetermined interval, for example, after one or more days, weeks, months, or years.

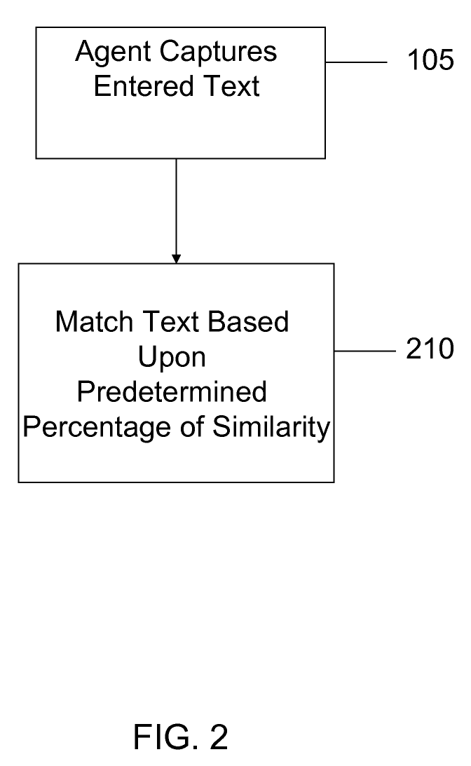

FIG. 2 illustrates an exemplary method in which entered text is matched based upon a predetermined percentage of similarity. Matching the text includes taking at least a portion of the entered text and comparing it to text already present in the database. When a predetermined percentage of the captured text matches text already in the database, a match occurs, 210. In at least one embodiment, the method stops after one match. However, in another embodiment, this method continues to search for additional matches that satisfy the predetermined percentage of similarity. The predetermined percentage used to match entered text to text already present in the database may be set by the user, for example, to 80% or more similarity, or 90% or more similarity.

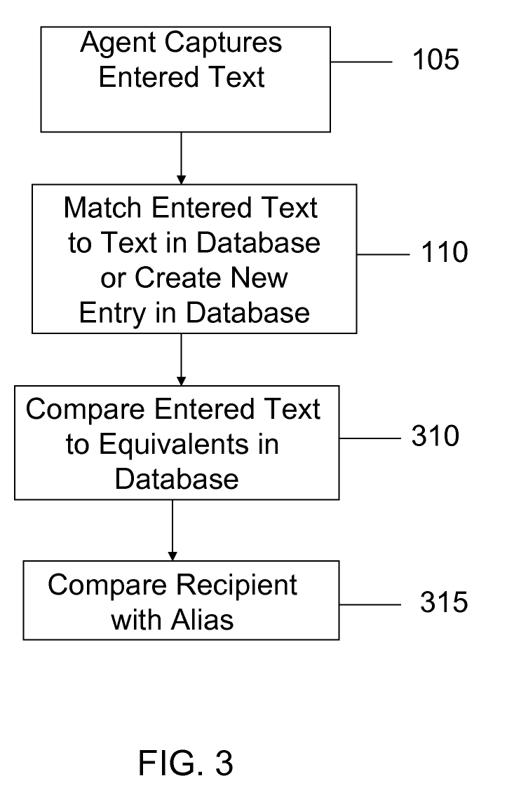

FIG. 3 illustrates an exemplary method for using equivalency to track uses of text and/or recipients. This method compares the entered text to database entries showing equivalent phrases and/or abbreviations for the entered text (e.g., “brb” being equivalent with “be right back” or “b-r-b”), 310. The method may also compare the at least one recipient with aliases for identifying the at least one recipient (e.g., when an individual has two or more screen-names or e-mail addresses), 315. In an embodiment, the method may compare entered text to database entries showing equivalent phrases and/or abbreviations by recipient classification. For example, if a recipient is classified in a group called “doctors”, then the abbreviation M.S. may be equivalent to multiple sclerosis. In contrast, if a recipient is classified in an “investor” group, the abbreviation M.S. may be equivalent to Morgan Stanley. The user may add, edit, or modify text contained in the database to provide for equivalent texts. The equivalency entries may be part of the main database or may be in a separate database.

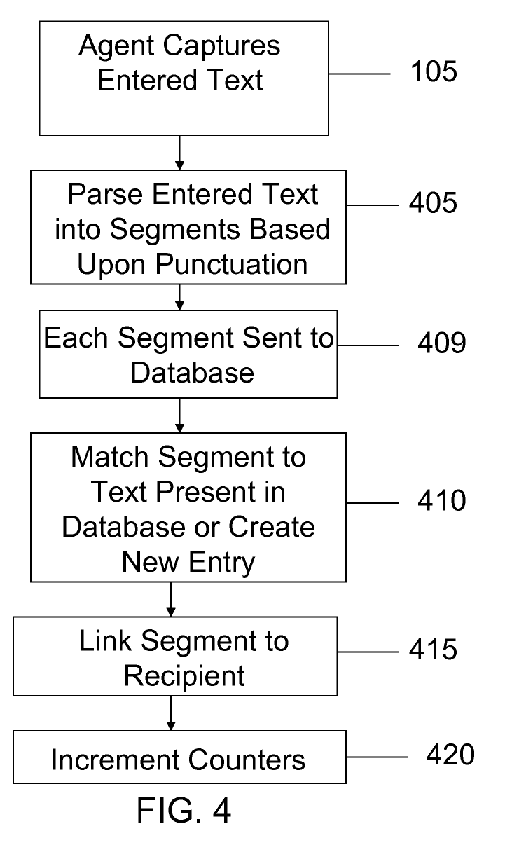

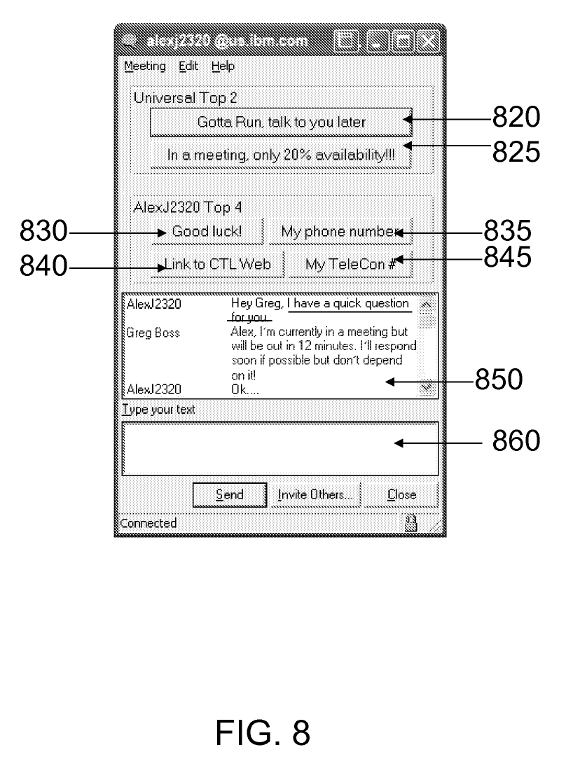

FIG. 4 illustrates an exemplary method for using punctuation marks to assist in breaking or parsing entered text. After capturing the text, the agent separates the text into discrete segments such as into sentences, phrases, or clauses based on the punctuation (e.g., commas, semicolons, colons, periods, questions marks, or exclamation points) of the entered text, 405. An example of this may be illustrated by FIG. 8. In the message from Greg Boss (the user), the message “Alex, I'm currently in a meeting but will be out in 12 minutes. I'll respond soon if possible but don't depend on it!” may be separated into the following three segments: (1) Alex; (2) I'm currently in a meeting but will be out in 12 minutes; and (3) I'll respond soon if possible but don't depend on it. Each text segment is sent to the database as individual pieces of captured text, 409. The individual text segments are matched to text present in the database or a new entry is made, 410. The individual text segments may also be linked to at least one recipient, 415. The respective counter(s) are incremented as discussed above, 420.

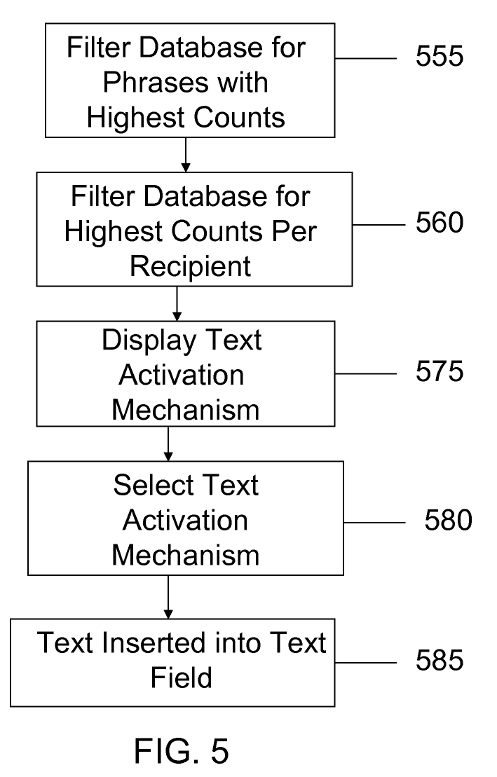

FIG. 5 illustrates an exemplary method for providing text to the user of a text environment. The agent applies a filter to the database for X number of texts that have the highest counts, 555. The agent in an exemplary embodiment tracking the recipient may also apply a separate filter to the database for Y number of texts that have the highest counts for at least one recipient, 560. Steps 560 and 555 may be performed concurrently or in reverse order than illustrated in FIG. 5. The agent displays at least one of the most highly-counted X and Y texts to the user, with each text being associated with at least one text activation mechanism, 575. In an embodiment, the text activation mechanisms may be a button displayed in a graphical user interface. For example, FIG. 8 illustrates an exemplary interface showing two universal selections (2 buttons corresponding to phrases having the highest number of counts) and four recipient specific selections (4 buttons corresponding phrases having the highest number of counts for a specific recipient). The user selects a text phrase by selecting the appropriate button, 580. After selecting the button, the agent inserts the selected phrase into the text field, 585, instead of the user having to type the text. Thus, the text activation mechanisms or buttons facilitate text entry and avoid retyping of the text. The button or activation mechanism may have a key shortcut. For example, Ctrl+m might activate that button and place the text in the editing field. In an embodiment of the invention, the top-counted entries or text activation mechanisms may be defined by the user of the text environment.

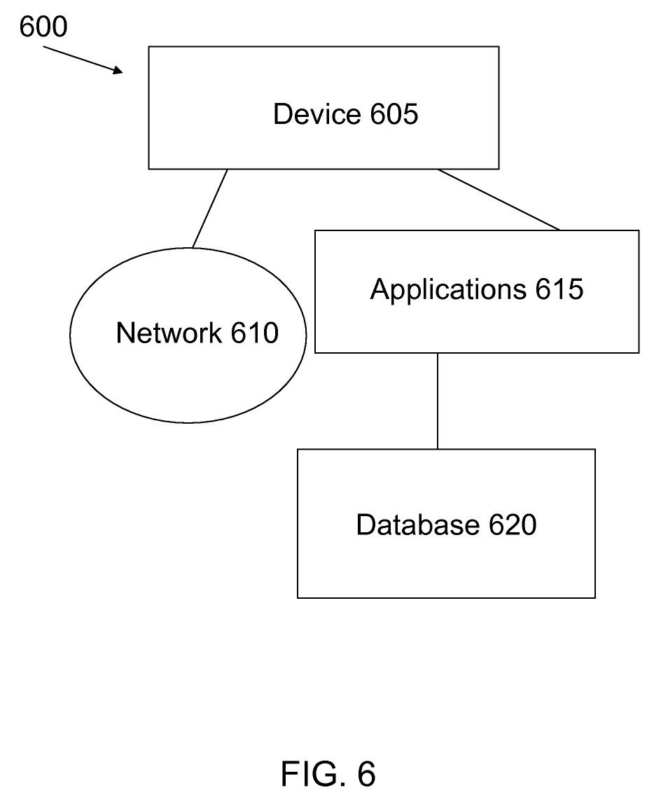

FIG. 6 is a block diagram showing an illustrative system of the invention, denoted by 600. The illustrative system includes one or more electronic or digital devices 605 (e.g., a personal computer, cellular telephone, personal digital assistant or PDA, MP3 player, television). The one or more devices may be connected to or interconnected to a network 610 (e.g., the Internet, or local area network (LAN)). In embodiments of the invention, the system may include at least one text application 615, such as e-mail applications, instant messaging application, text messaging applications, word processors, text editors, or any other application utilizing text functionality. The at least one text application 615 may reside on the device or on a separate server. The at least one text application may access storage such as at least one database 620 that may store text words or phrases, e-mails, IM messages, text messages, word processing documents, or other application data for analyzing a user's text input. The illustrative system is but one example and one of ordinary skill in the art would recognize that many other variations may exist, all of which are contemplated by the invention.

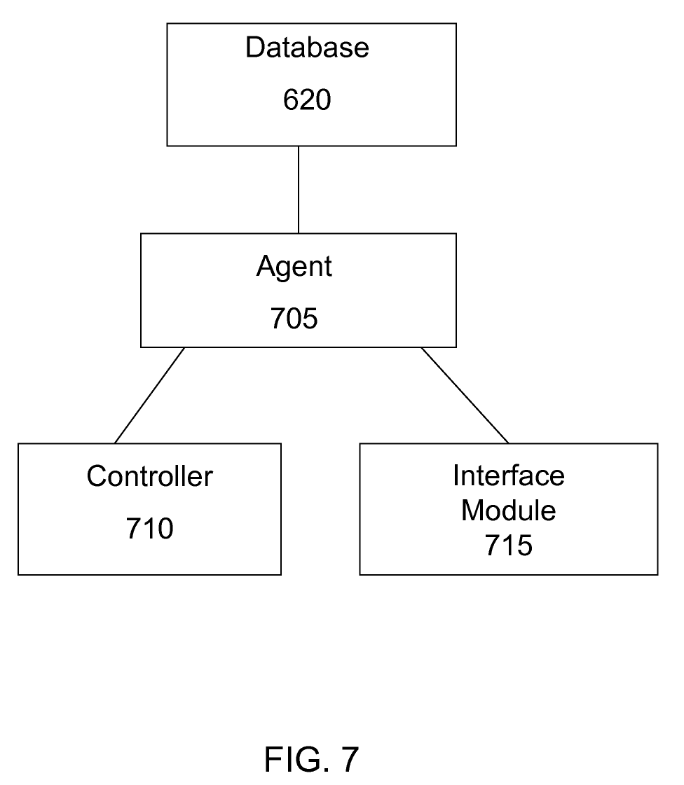

FIG. 7 illustrates an exemplary embodiment of the invention which includes a database and an agent 705, which may be an application. The agent in at least one embodiment includes a controller 710 and interface module 715. In an embodiment of the invention, the database includes fields for messages/text, at least one counter, at least one recipient, or any combination thereof. The information contained in the database originates from the controller based on information entered in the interface module of the text environment.

The controller provides a link between the text environment of the interface module and the database. The controller captures the text entered into a text field of the interface module. As illustrated in FIG. 1, the controller increments a counter for text that has been previously entered, or creates a new entry for the text in the database and sets the counter to one. For each piece of text, there may be an index of recipients in the database. Each recipient is linked with a counter that tracks the number of times a piece of text is sent to the recipient. If a recipient was not in the database for a specific piece of text, the controller adds the recipient to the database and sets the recipient counter to one. In embodiments where the interface module includes (or the option for) areas that provide text options other than text phrases, then the controller provides the respective additional information to the database. For example, in a temporal embodiment, the controller provides the current time to the database, which includes a field for this information. In at least one embodiment, the user can also process other text material for providing information to the database.

In at least one embodiment, the controller tracks text entered into two or more text environments (e.g., instant messaging and e-mail) and provides that information to one central database or, alternatively, to a database for each particular text environment.

In at least one embodiment, the controller segments the text at different points and compares to text segments present in the database to determine if a match is present. One approach to text selection is to take a predetermined fixed percentage of similarity for the entire text or of a text phrase, as shown in FIG. 2. The predetermined percentage of similarity in at least one embodiment may be user-selected. In other embodiments, the controller may consider the entire text message as the segment.

In at least one embodiment, the user may select the type of text segmentation implemented by the controller. In an exemplary embodiment of the invention, the controller breaks the entered text into segments based on the presence of punctuation. An example of this is shown in FIG. 4, in which the instant message from Greg Boss (the user) is parsed into three segments based upon punctuation. The controller sends each segment to the database as individual pieces of text.

The interface module not only provides a field for a user to enter text, but also according to the invention provides text activation mechanisms for use during a particular session. FIG. 8 provides an exemplary interface module in an instant messaging graphical user interface (GUI). The interface module 715 shows two universal text selections 820, 825 (2 buttons corresponding to phrases or segments having the highest number of counts) and four recipient specific text selections 830, 835, 840, 845 (4 buttons corresponding to phrases or segments having the highest number of counts for a specific recipient). The illustrated messaging interface also includes a dialog box 850 showing the current instant messaging exchange and an input field 860. The input field is populated by user-inputted information like entered text and/or by text selected from the buttons. The number of text phrases available under the universal and recipient areas in at least one embodiment may be user-settable.

In an embodiment of the system of the invention, a temporal filter may track text phrases frequently used over a specific time period (e.g., the last hour, the last day, the last few days, and the last week). The system may also include a search engine or database management system which allows the user to search the database.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Computer program code for carrying out operations of the present invention may be written in a variety of computer programming languages. The program code may be executed entirely on at least one computing device, as a stand-alone software package, or it may be executed partly on one computing device and partly on a remote computer. In the latter scenario, the remote computer may be connected directly to the one computing device via a LAN or a WAN (for example, Intranet), or the connection may be made indirectly through an external computer (for example, through the Internet, a secure network, a sneaker net, or some combination of these).

It will be understood that each block of the flowchart illustrations and block diagrams and combinations of those blocks can be implemented by computer program instructions and/or means. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowcharts or block diagrams.

The exemplary and alternative embodiments described above may be combined in a variety of ways with each other. Furthermore, the steps and number of the various steps illustrated in the figures may be adjusted from that shown.

Although the present invention has been described in terms of particular exemplary and alternative embodiments, it is not limited to those embodiments. Alternative embodiments, examples, and modifications which would still be encompassed by the invention may be made by those skilled in the art, particularly in light of the foregoing teachings.

1. A method for providing text in text environments, comprising:
capturing text entered by a user of a text environment;
matching the entered text to text in a database;
when no match occurs, creating a new entry in the database for the entered text;
counting the number of times the text is used; and
displaying at least one of the most highly-counted texts as at least one text activation mechanism to facilitate text entry and avoid retyping of the text.

2. A method according to claim 1, further comprising:
linking the entered text to at least one recipient; and
counting the number of times the entered text is sent to the at least one recipient.

3. A method according to claim 1, wherein said matching comprises comparing the entered text with text in the database based upon a predetermined percentage of similarity.

4. A method according to claim 3, wherein the predetermined percentage of similarity is at least 80% similarity between the entered text and text in the database.

5. A method according to claim 1, further comprising comparing the entered text to database entries showing equivalent phrases or abbreviations for the text.

6. A method according to claim 2, further comprising comparing the at least one recipient with aliases identifying the at least one recipient.

7. A method according to claim 1, further comprising parsing the entered text into discrete segments based on the punctuation of the entered text.

8. A method according to claim 1, wherein at least one text activation mechanism displays at least one text having the highest count.

9. A method according to claim 1, wherein at least one text activation mechanism comprises at least one text having the highest counts for at least one recipient.

10. A method according to claim 1, wherein the at least one text activation mechanism comprises a button displayed in a graphical user interface.

11. A method according to claim 1, wherein the at least one text activation mechanism is defined by a user of the text environment.

12. A method according to claim 1, wherein the at least one text activation mechanism has a key shortcut.

13. A method according to claim 1, wherein the text environment is at least one environments selected from the group consisting of an e-mail application, a text messaging application, a word processing application, and a text editor.

14. A method according to claim 1, wherein the text messaging application comprises instant messaging, cellular telephone text messaging, or PDA text messaging.

15. A method for providing text, comprising:
capturing text entered by a user of an instant messaging application;
matching the entered text to text in a database;
when no match occurs, creating a new entry in the database for the entered text;
counting the number of times the text is used; and
displaying at least one of the most highly-counted texts as at least one text activation mechanism in a graphical user interface of the instant messaging application.

16. A method according to claim 15, further comprising:
linking the entered to text to at least one recipient;
counting the number of times the entered text is sent to the at least one recipient; and
displaying at least one of the most highly-counted texts for the at least one recipient as at least one text activation mechanism in the graphical user interface of the instant messaging application.

17. A system, comprising:
an agent comprising:
a controller, and
an interface module,
wherein the controller captures text and increments a counter for text that has been previously entered in a text environment,
wherein the interface module comprises at least one text activation mechanism to facilitate text entry and avoid retyping of the text.

18. A system according to claim 17, further comprising a database, wherein the information contained in the database originates from the controller based on information entered in the interface module.

19. A computer program product, comprising:
a computer useable medium having a computer readable program, wherein the computer readable program when executed on a computer causes the computer to:
capture text entered by a user in a database for a text environment;
match the entered text to text in the database;
create an entry in the database if the text is not present in the database;
count the number of times the text is used; and
display at least one of the most highly-counted texts as a text activation mechanism to facilitate text entry and avoid retyping the text.
